(19) United States
(12) Patent Application Publication
(10) Pub. No.: US 2009/0017201 A1
(43) Pub. Date: Jan. 15, 2009

(54) METHOD FOR COATING OR DECOATING A COMPONENT

(75) Inventors: Matthias Schmidt, Brehna (DE); Georgios Paronis, Augsburg (DE); Anton Albrecht, Bad Koetzting (DE)

Correspondence Address: CROWELL & MORING LLP;INTELLECTUAL PROPERTY GROUP, P.O. BOX 14300, WASHINGTON, DC, 20044-4300, US

(73) Assignee: MTU Aero Engines GmbH, Munich (DE)

(21) Appl. No.: 12/064,920

(22) PCT Filed: Aug. 22, 2006
(86) PCT No.: PCT/DE2006/001467

§ 371 Date: Aug. 27, 2008

(30) Foreign Application Priority Data
Sep. 2, 2005 (DE) 10 2005 041 844.9

(51) Int. Cl. B05D 5/00

(52) U.S. Cl. 427/154

(57) ABSTRACT

The invention relates to a method for coating or decoating a component, in particular a gas turbine component, wherein, in order to regionally or partially coat or decoat a component, the component is preferably completely covered with a covering medium, and wherein the covering medium is removed from only those surface regions of the component in which the coating or decoating of the component is supposed to take place, so that a surface region of the component which is not to be coated or decoated is covered by the covering medium. According to the invention, the covering medium is removed by means of water jet machining.

This application claims the priority of International Application No. PCT/DE2006/001467, filed Aug. 22, 2006, and German Patent Document No. 10 2005 041 844.9, filed Sep. 2, 2005, the disclosures of which are expressly incorporated by reference herein.

### BACKGROUND AND SUMMARY OF THE INVENTION

The invention relates to a method for coating or decoating a component, in particular a gas turbine component.

Components of a gas turbine, such as the rotor blades, for example, are provided completely or partially with special coatings on their surfaces in order to render them resistant to oxidation, resistant to corrosion or even resistant to erosion. Special coating methods are used for this. Because the components of gas turbines are subject to wear during operation of the gas turbines or may be damaged in another manner, in order to repair damage, it is necessary as a rule to remove or strip off the coating regionally or even completely from the component that is to be repaired.

In the case of partial or regional coating and decoating of a component, coatings are applied to or removed from the component only on the specified surface regions. In order to avoid coating or decoating in the surface regions that are not to be coated or decoated, the surface regions that are not to be coated or decoated are covered with a covering medium, wherein, to do so, the procedure is first to cover the entire component with the covering medium and then to remove the covering medium from the surface regions where a coating or decoating of the component is supposed to take place, so that the covering medium only remains on the component in the surface regions that are not to be coated or decoated. Removing the covering medium from the component to expose the surface regions, on which a coating or decoating is supposed to take place, occurs according to the prior art by manually removing the covering medium with the support of chemical cleaning agents. This is laborious and expensive.

Starting herefrom, the present invention is based on the objective of creating a novel method for coating or decoating a component.

According to the invention, the covering medium is removed by water jet machining.

In terms of the present invention, removing the covering medium from the surface regions of the component, in which the component is supposed to be coated or decoated, is accomplished with the aid of water jet machining. Water jet machining can be conducted automatically as far as possible so that it is possible to dispense with laborious, as well as costly manual processing steps as much as possible. By using water jet machining to remove the covering medium, it is also possible to dispense with chemical cleaning agents. Furthermore, the surface regions from which the covering medium is supposed to be removed can be defined via a CAD system so that the covering medium can be removed true-to-contour from the relevant surface regions of the component. This makes highly-precise, regional or partial coating or decoating of components possible.

According to an advantageous development of the invention, the water jet machining is conducted as high-pressure water jet machining at a pressure between 100 bar and 1000 bar, wherein a distance between the surface region of the component to be freed of the covering medium and a jet nozzle is between 10 mm and 60 mm, and wherein an angle between a water jet being formed and the surface region of the component to be freed of the covering medium is between 30° and 90°.

Preferred developments of the invention are disclosed in the subsequent description.

### DETAILED DESCRIPTION OF AN EXEMPLARY EMBODIMENT

The invention relates to a method for coating or decoating a component, namely for regionally or partially coating or decoating a component. The inventive method is used preferably for partially coating or decoating gas turbine components, which are formed of a nickel-based material or a titanium-based material.

To partially coat or partially decoat a component, a component is completely covered with a covering medium, wherein the covering medium is removed from only those surface regions of the component in which the coating or the decoating of the component is supposed to take place.

In all other surface regions of the component, in which the coating or decoating is not supposed to take place, however, the covering medium remains on the component in order to protect the surface regions of the component that are not supposed to be coated or decoated from the coating or decoating.

In terms of the present invention, it is provided that the covering medium be removed from the surface regions, in which the coating or decoating of the component is supposed to take place, by water jet machining, namely by high-pressure water jet machining. The high-pressure water jet machining to remove the covering medium, which is preferably designed as a wax or lacquer layer, takes place preferably in this case at a jet pressure between 100 bar and 1000 bar. The water jet machining in this case is conducted in such a way that a distance between the surface of the component to be freed of the covering medium and a jet nozzle, via which a water jet is aimed at the component, is between 10 mm and 60 mm. A wide slot nozzle is preferably used as the jet nozzle. Furthermore, the water jet machining is conducted in such a way that the water jet being formed and a surface section from which the covering medium is to be removed, enclose an angle of between 30° and 90°, preferably an angle of between 45° and 90°. The angle between the water jet and the surface of the component from which the covering medium is to be removed is preferably between 45° and 60°. During water jet machining, a relative movement with a feed rate of between 100 mm/s and 300 mm/s is established between the component and the jet nozzle, which aims the water jet at each surface region of the component that is to be freed of covering medium. In this case, the jet nozzle is preferably moved relative to the stationary component. However, it is also possible to move the component relative to a stationary jet nozzle. In just the same way, both the component and the jet nozzle can be moved to supply the relative movement. The relative movement between the component and the jet nozzle is preferably automated, wherein the regions from which the covering medium is supposed to be removed with the aid of water jet machining can be defined or specified using a CAD system. This results in a highly precise and true-to-contour removal of the covering medium from the surface regions of the component, in which only a coating or decoating of the component is supposed to take place. Surface regions of the component that are not to be coated or decoated remain covered by the covering medium, however.

1-9. (canceled)

10. A method for coating or decoating a component, in particular a gas turbine component, wherein, in order to regionally or partially coat or decoat the component, the component is covered with a covering medium, and wherein the covering medium is removed from only those surface regions of the component in which the coating or decoating of the component is supposed to take place, so that a surface region of the component which is not to be coated or decoated remains covered by the covering medium, and wherein the covering medium is first completely and directly applied to the component and then the covering medium is removed from the surface region that is to be coated or decoated by means of water jet machining.

11. The method according to claim 10, wherein the water jet machining is conducted as high-pressure water jet machining

12. The method according to claim 11, wherein a pressure of the high-pressure water jet machining is between 100 bar and 1000 bar.

13. The method according to claim 10, wherein the water jet machining is conducted such that a distance between a surface region of the component to be freed of the covering medium and a jet nozzle, via which a water jet is aimed at the surface region to be freed of the covering medium, is between 10 mm and 60 mm.

14. The method according to claim 10, wherein the water jet machining is conducted such that a water jet and a surface region of the component to be freed of the covering medium enclose an angle of between 30° and 90°.

15. The method according to claim 14, wherein the water jet and the surface region of the component to be freed of the covering medium enclose an angle of between 45° and 60°.

16. The method according to claim 10, wherein the water jet machining is conducted such that a relative speed of between 100 mm/s and 300 mm/s is established between the component and a jet nozzle.

17. The method according to claim 10, wherein the water jet machining is conducted with a wide slot nozzle.

18. The method according to claim 10, wherein the water jet machining is conducted for removing a covering medium from a gas turbine component made of a titanium-based material or a nickel-based material.

19. The method according to claim 10, wherein polymers, lacquer or wax are removed as the covering medium.

20. A method for coating or decoating a component, comprising the steps of:
applying a covering medium on the component, wherein the covering medium completely covers the component and is directly applied to the component;
removing the covering medium from the component by water jet machining only in a region of the component that is to be coated or decoated; and
coating or decoating the component in the region where the covering medium is removed.

21. The method according to claim 20, wherein the component is a gas turbine component.

22. The method according to claim 20, further comprising the step of defining the region by a computer aided design (CAD) system.

23. The method according to claim 20, wherein the covering medium is a wax or lacquer.
